(19) United States
(12) Patent Application Publication
(10) Pub. No.: US 2019/0138463 A1
(43) Pub. Date: May 9, 2019

(54) INFORMATION PROCESSING APPARATUS, INFORMATION PROCESSING METHOD, AND PROGRAM

(71) Applicant: SONY CORPORATION, TOKYO (JP)

(72) Inventors: MASATOMO KURATA, TOKYO (JP); YOSHIYUKI KOBAYASHI, TOKYO (JP); YOSHIHIRO WAKITA, TOKYO (JP)

(21) Appl. No.: 16/301,136

(22) PCT Filed: Mar. 30, 2017
(86) PCT No.: PCT/JP2017/013431

§ 371 Date: Nov. 13, 2018

(30) Foreign Application Priority Data
May 26, 2016 (JP) 2016-105277

(51) Int. Cl. G06F 13/12; G06F 3/01; H04W 4/21; G06Q 50/00; G06F 9/54; H04N 21/422

(52) U.S. Cl. CPC G06F 13/128; G06F 3/01; H04N 21/42201; G06Q 50/01; G06F 9/543; H04W 4/21

(57) ABSTRACT

[Object] To enable a user's feeling at the time of recording to be experienced by another user.

[Solution] An information processing apparatus according to the present disclosure includes: a display controller that causes display that urges a user to perform an operation for playing back content that is associated with at least one piece of bio-information to be performed on a display section; and a playback controller that, in accordance with the operation by the user, acquires the bio-information and the content from a storage section that stores the bio-information and the content, and causes the bio-information and the content to be played back. This configuration enables the user's feeling at the time of recording content to be experienced by another user.

### TECHNICAL FIELD

The present disclosure relates to an information processing apparatus, an information processing method, and a program.

### BACKGROUND ART

Conventionally, for example, Patent Literature 1 below describes that, when a current location is measured or indicated at a user terminal and the current location is transmitted to a server, the server transmits, to the user terminal, image information of a picture that is photographed at a location within a predetermined distance with respect to the current location, information indicating a photographing location, and bio-information of a photographer at the time of photographing.

### CITATION LIST

### Patent Literature

Patent Literature 1: JP 2009-187233A

### DISCLOSURE OF INVENTION

### Technical Problem

Recently, service of recording pictures, sounds, and activity information, and of making them public has been widespread. However, it is difficult to simply share a feeling of a user at the time of recording, without the user's explanation or interpretation.

In the technology described in the above-described Patent Literature 1, information in which content information such as images, sounds, and location information and bio-information are combined is not displayed in a listed manner for each user. Therefore, an issue of the reduction in convenience has occurred. Specifically, bio-information and information of an image that is photographed within a range corresponding to a current location of a user terminal are transmitted to the user terminal, a result of which information that is receivable at the user terminal is restricted. Therefore, it is not possible for the user to acquire desired image information or bio-information in a case where the user has not reached the location, which causes the issue of the reduction in convenience.

To address this, it has been desired to enable a user's feeling at the time of recording content to be experienced by another user.

### Solution to Problem

According to the present disclosure, there is provided an information processing apparatus including: a display controller that causes display that urges a user to perform an operation for playing back content that is associated with at least one piece of bio-information to be performed on a display section; and a playback controller that, in accordance with the operation by the user, acquires the bio-information and the content from a storage section that stores the bio-information and the content, and causes the bio-information and the content to be played back.

In addition, according to the present disclosure, there is provided an information processing method including: causing display that urges a user to perform an operation for playing back content that is associated with at least one piece of bio-information to be performed on a display section; and acquiring, in accordance with the operation by the user, the bio-information and the content from a storage section that stores the bio-information and the content, and causing the bio-information and the content to be played back.

In addition, according to the present disclosure, there is provided a program that causes a computer to function as: a means of causing display that urges a user to perform an operation for playing back content that is associated with at least one piece of bio-information to be performed on a display section; and a means of, in accordance with the operation by the user, acquiring the bio-information and the content from a storage section that stores the bio-information and the content, and causing the bio-information and the content to be played back.

### Advantageous Effects of Invention

As described above, according to the present disclosure, it enables the user's feeling at the time of recording content to be experienced by another user.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a schematic diagram illustrating an outline configuration of a system according to one embodiment of the disclosure.

FIG. 2 is a schematic diagram illustrating a server configuration.

FIG. 3 is a schematic diagram illustrating states of acquiring bio-information and information of an image, a sound, and an activity (motion), and of recording them in a database.

FIG. 4 is a schematic diagram illustrating a user interface (UI) of a social network service.

FIG. 5 is a schematic diagram illustrating, in addition to a display example on a timeline illustrated in FIG. 4, a display example that displays, on a map, content with bio-information, and a display example that performs AR display in a case where a user arrives at a corresponding location on the map.

FIG. 6 is a schematic diagram illustrating a case in which an HMD, a speaker, a vibration generator, and a humidifier are selected as a vicarious experience apparatus.

FIG. 7 is a schematic diagram illustrating an example in which content with bio-information of an idle singer is made public on a timeline of a social network.

FIG. 8 is a schematic diagram illustrating an example of a presentation (instruction) of a vicarious experience method by a vicarious experience method presentation section.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

It is to be noted that a description is given in the following order.

### 1. Configuration Example of System

### 2. Configuration Example of Server

3. Specific Examples of Vicarious Experience by way of Content with Bio-Information

### 1. Configuration Example of System

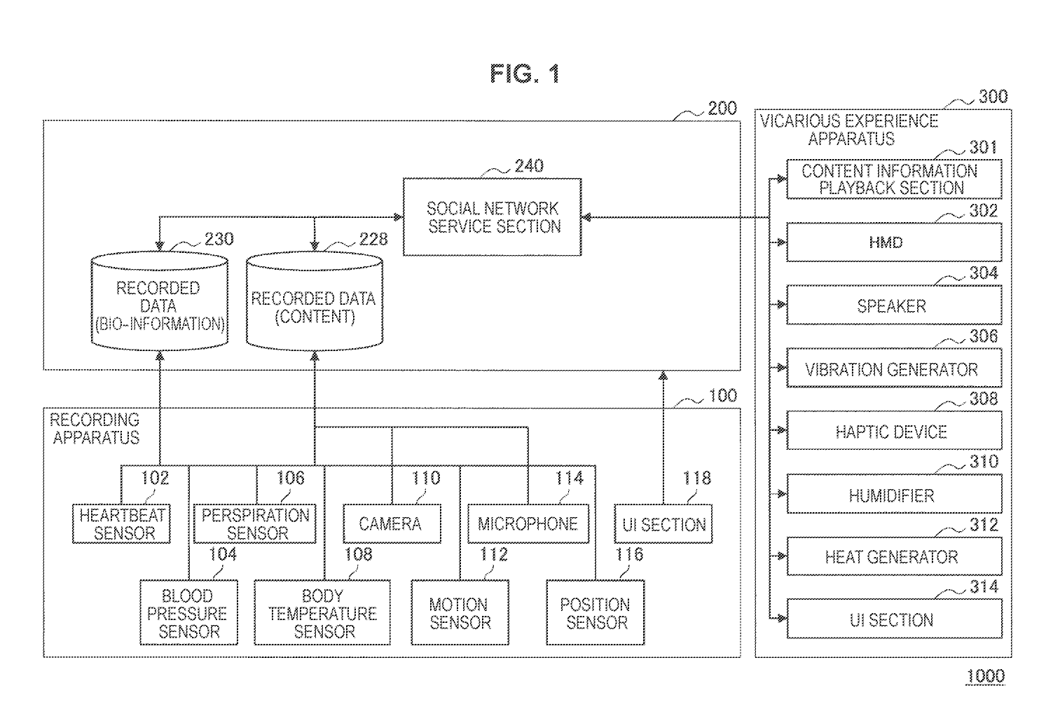

First, with reference to FIG. 1, a description is given of an outline configuration of a system 1000 according to one embodiment of the present disclosure. The system 1000 according to the present embodiment allows bio-information that is recorded in combination with a picture, a sound, and activity information to be made public, as content, on the internet by using a social network service (SNS), etc. Thereafter, in a case where another user selects the content, the system allows another user to vicariously experience a situation at the time of recording by using the bio-information in combination with content playback.

Specifically, the bio-information (heartbeat, pulse wave, perspiration, etc.) is acquired by a sensor device, and is recorded in a database. The bio-information is recorded in combination with content information such as a text, an image, and a sound. The combined bio-information is shared via a social network service (SNS), etc. Another user selects the content information such as a text, an image, and a sound that is associated with the shared bio-information. Further, a vicarious experience apparatus that allows a user to vicariously experience the bio-information is worn by the user. When the user selects the content information that is associated with the bio-information, the vicarious experience apparatus is operated, and a pattern of the bio-information is reproduced by the vicarious experience apparatus. This allows the user to vicariously experience a state of tension or a state of excitement together with the content information.

As illustrated in FIG. 1, the system 1000 according to the present embodiment includes a recording apparatus (detection apparatus) 100, a server 200, and a vicarious experience apparatus 300. The recording apparatus 100 and the server 200 are coupled to each other in a communicable manner via a network such as the Internet. Similarly, the server 200 and the vicarious experience apparatus 300 are coupled to each other in a communicable manner via a network such as the Internet. It is to be noted that, so long as the recording apparatus 100 and the server 200 or the server 200 and the vicarious experience apparatus 300 are coupled to each other in a communicable manner wiredly or wirelessly, a technique therefor is non-limiting.

The recording apparatus 100 is worn by a person from which bio-information is acquired (hereinafter, also referred to as a bio-information acquisition target), and acquires various types of information including the bio-information of the person. Therefore, the recording apparatus 100 includes a heartbeat sensor 102, a blood pressure sensor 104, a perspiration sensor 106, a body temperature sensor 108, a camera 110, a motion sensor 112, a microphone 114, and a position sensor 116. The information acquired by the recording apparatus 100 is transmitted to the server 200, and recorded. The motion sensor 112 includes an acceleration sensor, a gyro sensor, a vibration sensor, etc. The motion sensor 112 acquires activity information relating to motions of the bio-information acquisition target. The position sensor 116 performs position detection by the technique such as GPS and Wi-Fi.

The vicarious experience apparatus 300 is worn by a user who vicariously experiences content including the bio-information (content with bio-information) (hereinafter, also referred to as a person vicariously experiencing bio-information). The vicarious experience apparatus 300 allows the user to vicariously experience the content with bio-information. The vicarious experience apparatus 300 includes an HMD (Head Mounted Display) 302, a speaker 304, a vibration generator 306, a haptic device 308, a humidifier 310, and heat generator 312.

### 2. Configuration Example of Server

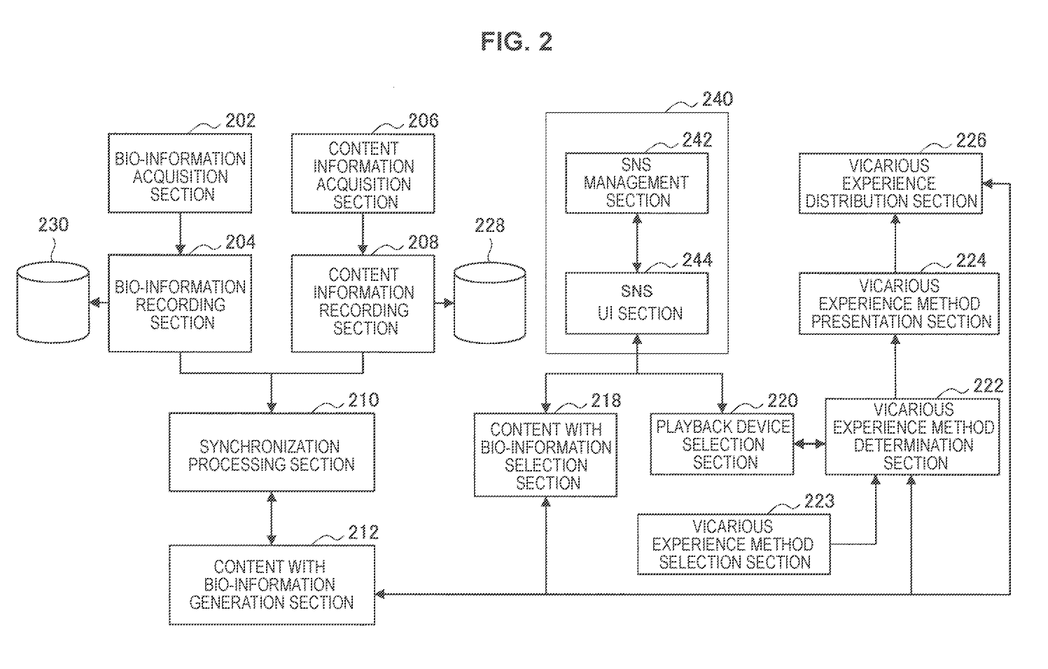

FIG. 2 is a schematic diagram illustrating a configuration of the server 200. The server 200 includes a bio-information acquisition section 202, a bio-information recording section 204, a content information acquisition section 206, a content information recording section 208, a synchronization processing section 210, a content with bio-information generation section 212, a content with bio-information selection section 218, a playback device selection section 220, a vicarious experience method determination section 222, a vicarious experience method selection section 223, a vicarious experience method presentation section 224, a vicarious experience distribution section (playback controller) 226, databases 228 and 230, and a social network service section 240. It is to be noted that it is possible to configure each component of the server 200 illustrated in FIG. 2 with use of hardware, or a central processing unit such as a CPU, and a program (software) that allows the CPU to function. In a case where each component of the server 200 is configured with the central processing unit such as a CPU and the program that allows the CPU to function, it is possible for the program to be stored in a recording medium such as memory included in the server 200.

The bio-information acquisition section 202 acquires bio-information (heartbeat, pulse wave, perspiration, etc.) that is detected by the sensors (bio-information sensors) such as the heartbeat sensor 102, the blood pressure sensor 104, the perspiration sensor 106, and the body temperature sensor 108, of the recording apparatus 100. The bio-information recording section 204 records the acquired bio-information in the database 230.

The content information acquisition section 206 acquires text information relating to bio-information, image information, sound information, and content information such as activity information. The content information recording section 208 records the acquired content information in the database 228. Regarding the image information, it is possible to acquire the image information relating to the bio-information acquisition target by the camera 110 of the recording apparatus 100. Further, regarding the sound information, it is possible to acquire the sound information relating to the bio-information acquisition target by the microphone 114 of the recording apparatus 100. Regarding the activity information, it is possible to acquire the activity information relating to the bio-information acquisition target by the motion sensor 112 and the position sensor 116 of the recording apparatus 100.

On the other hand, it is possible for the content information acquisition section 206 to acquire content information from an apparatus other than the recording apparatus 100. For example, in a case of photographing an image of the bio-information acquisition target by an external camera that is located away from the bio-information acquisition target, it is possible for the content information acquisition section 206 to acquire the image information from the external camera.

The synchronization processing section 210 performs processing of temporally synchronizing the bio-information with the content information. The content with bio-information generation section 212 combines the bio-information and the content information that are synchronized temporally, in accordance with a selected condition, and generates the content with bio-information. It is possible to select the combination of the bio-information with the content information by a user performing input to the vicarious experience method selection section 228. For example, in a case where a plurality of pieces of bio-information is acquired, it is possible for the user to select whether to combine one or more than one of the plurality of pieces of bio-information with the content information. Further, in a case where a vicarious experience method is fixed in accordance with a function of the vicarious experience apparatus 300, a combination of the content information and the bio-information that is suitable for the vicarious experience method is selected, and content information with bio-information is generated. Therefore, the content with bio-information generation section 212 acquires information relating to the function of the vicarious experience apparatus 300 from the vicarious experience apparatus 300. Further, it is possible for the content with bio-information generation section 212 to perform digest edit, by way of signal processing of the bio-information and content analysis technique of information of a text, a sound, and an image.

The social network service section 240 includes a social network management section (SNS management section) 242 and a social network user interface section (SNS-UI section, display controller) 244. It is to be noted that the social network service section 240 may be provided at a separate server (a social network server) from the server 200. In this case, it is possible to perform similar processing by the server 200 cooperating with the social network server.

The SNS-UI section 244 is a user interface that allows the user to access the social network service. Information relating to the user interface is provided to a terminal of the bio-information acquisition target and a terminal of the person vicariously experiencing bio-information; however, the information may also be provided to the recording apparatus 100 and the vicarious experience apparatus 300. In the present embodiment, as an example, the bio-information acquisition target operates the user interface that is provided at the recording apparatus 100 to access the social network service, and the person vicariously experiencing bio-information operates the user interface that is provided at the vicarious experience apparatus 300 to access the social network service. Therefore, the recording apparatus 100 includes a user interface (UI) section 118, and the vicarious experience apparatus 300 includes the user interface (UI) section 314. As an example, the UI sections 118 and 314 are each configured with a touch panel including a liquid crystal display and a touch sensor. It is to be noted that the recording apparatus 100 or the vicarious experience apparatus 300 and a terminal at which the user interface is provided may be separated from each other, and the recording apparatus 100 or the vicarious experience apparatus 300 and the terminal may also be communicable.

On the user interface (UI) of the SNS-UI section 244, the user (the bio-information acquisition target) sets conditions such as user management and an area open to the public of SNS. In accordance with these conditions, information relating to the content with bio-information (name, time of acquiring information, thumb nail, and other information) is made public on the social network service. Thereafter, the user (the person vicariously experiencing bio-information) selects a later-described “vicarious experience button” on the basis of the information that has been made public, thereby the information including such details is transmitted from the UI section 314 to the SNS-UI section 244, and further transmitted from the SNS-UI section 244 to the content with bio-information selection section 218. This allows the content with bio-information selection section 218 to select content with bio-information designated by the user.

The playback device selection section 220 selects a condition of playback devices (the vicarious experience apparatus 300) that provide a vicarious experience of the bio-information. This condition includes a condition to designate one, for use, of the playback devices included in the vicarious experience apparatus 300. Further, the user may select this condition via the SNS-UI section 244. Alternatively, the user and the vicarious experience apparatus 300 may be managed, with conditions, at the SNS management section 242, and the vicarious experience 300 may be selected on the basis of a condition, etc. that is selected by the user, or may be automatically selected by the SNS management section 242. Further, the playback device selection section 220 may select a condition of the vicarious experience apparatus 300 on the basis of the bio-information included in the content with bio-information.

In a case where the content with bio-information and a condition of the vicarious experience apparatus 300 are determined, the vicarious experience method determination section 222 determines, on the basis of the information associated with them, a vicarious experience method such as wearing and a setting procedure of a playback device, for the vicarious experience. For example, the vicarious experience method determination section 222 determines the vicarious experience method on the basis of a type of the playback devices included in the vicarious experience apparatus 300. Further, the vicarious experience method determination section 222 determines, on the basis of an instruction from the user going through the vicarious experience (the person vicariously experiencing bio-information), the vicarious experience method. The vicarious experience method presentation section 224 presents the vicarious experience method to the user going through the vicarious experience by using a method such as a text, an image, and a sound. The information presented by the vicarious experience method presentation section 224 is transmitted to the UI section 314 of the vicarious experience apparatus 300 and displayed on a screen. It is possible for the user to recognize a wearing method, a wearing location, a setting method, etc. of the playback device for vicariously experiencing the bio-information by referring to a displayed vicarious experience method. Therefore, it is possible for the user to wear and use the playback device in a proper state.

The vicarious experience distribution section 226 transmits a playback signal relating to the bio-information to the vicarious experience apparatus 300, and causes the vicarious experience apparatus 300 to execute a vicarious experience operation based on the playback signal relating to the bio-information. The vicarious experience apparatus 300 is operated on the basis of a vicarious experience signal. This allows the user to vicariously experience a state of tension or a state of excitement via the vicarious experience apparatus 300.

Further, the vicarious experience distribution section 226 transmits, to the vicarious experience apparatus 300, a playback signal relating to content information together with the bio-information, and causes the vicarious experience apparatus 300 to execute a vicarious experience operation based on the playback signal relating to the content information. A content information playback section 301 of the vicarious experience apparatus 300 plays back the content information on the basis of the playback signal relating to the content information. This allows the user to view the content information via the vicarious experience apparatus 300.

With such a configuration as described above, it is possible to acquire and record the bio-information (heartbeat, pulse wave, perspiration, etc.) at the recording apparatus 100, and share, on a social network service, the recorded bio-information together with the content information indicating a text, an image, a sound, an activity, etc. By another user (the person vicariously experiencing bio-information) selecting the content with the bio-information that is associated with the shared bio-information, a pattern of the bio-information that is associated with the content is reproduced. This allows another user to vicariously experience a state of tension or a state of excitement.

3. Specific Examples of Vicarious Experience by Way of Content with Bio-Information

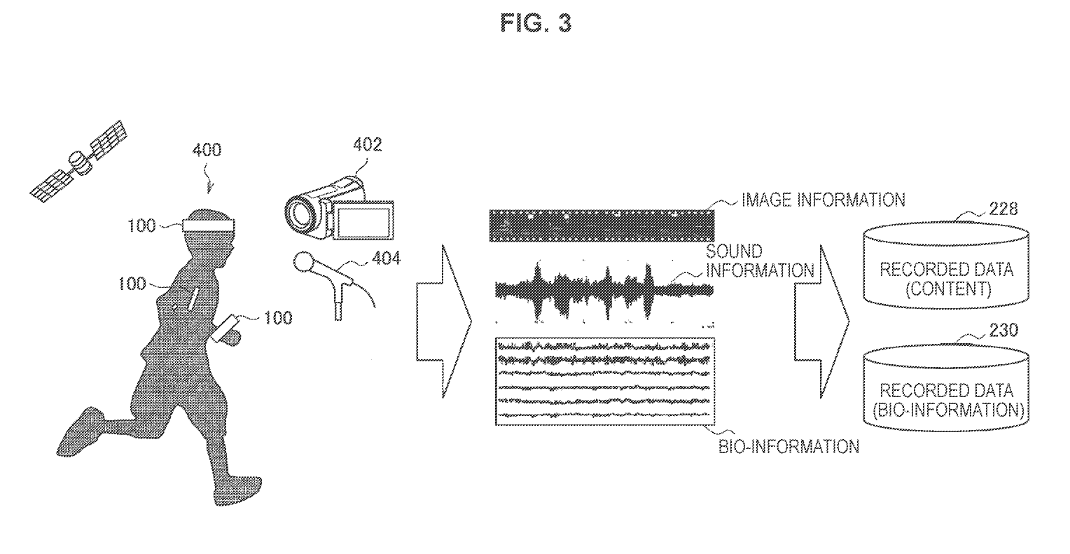

In the following, description is given, by way of an example, of a case in which a user (a family: for example, a grandfather) vicariously experiences a situation in a sports meeting of a child (a bio-information acquisition target) 400. FIG. 3 is a schematic diagram illustrating states of acquiring bio-information and information of an image, a sound, and an activity (motion), and recording them in databases (storage section) 228 and 230. First, as illustrated in FIG. 3, the child 400 wears the recording apparatus 100 on the body to record bio-information (heartbeat, perspiration, blood pressure, body temperature, etc.) during an event such as a sports meeting and content information such as an image, a sound, and an activity (motion). In a case of acquiring information of the activity (motion), the information may be acquired in cooperation with a positioning system such as GPS, WiFI, and UWB. Further, in a case of acquiring information of an image or a sound, the information may be acquired in cooperation with an installation-type external camera 402, an installation-type external microphone 404, or the like. In order to acquire the bio-information and the content information, various types of bio-information sensors, a camera, a microphone, a motion sensor, a positional sensor, and the like may be mounted to a wearable device such as an HMD or a watch-type device that is worn by the bio-information acquisition target.

The bio-information and the content information acquired by the recording apparatus 100 is transmitted to the server 300, and acquired at the bio-information acquisition section 202 and the content information acquisition section 206. Thereafter, the acquired bio-information and the content information such as an image, a sound, an activity (motion), and location information are temporally synchronized by the synchronization processing section 210. The content with bio-information is generated on the basis of the bio-information and the content information such as image information, sound information, and activity information (location information). The bio-information and the content information are recorded in the databases 228 and 230. At this occasion, the bio-information and the content information may be recorded in the separate databases 228 and 230 in a state of the content information being associated with the bio-information. Alternatively, the content with bio-information in which the bio-information and the content information are combined may be collectively recorded in one database. Meta data such as text data relating to details of content is saved in accordance with the content with bio-information.

Next, the SNS-UI section 244 of the social network service section 240 allows the recorded content with bio-information to be made public on a social network service. The SNS management section 242 of the social network service section 240 sets an area open to the public of the content on the basis of a designation from a user, and allows the content to be made public. In a case where a person located remotely (for example, the grandfather of the child) wears the vicarious experience apparatus 300 on the body, selects the content with bio-information that has been made public, and presses an “experience button”, the vicarious experience apparatus 300 plays back vibration, humidity control, and heat generation control on the basis of a bio-information signal, and play backs content information such as a picture and sound that are synchronized with the bio-information. It is to be noted that the detection of a gesture or a sound input also allows for the playback of the bio-information and the content information, similarly to a case where the “experience button” is selected, with a user's performance of a predetermined gesture or a sound input being as a trigger.

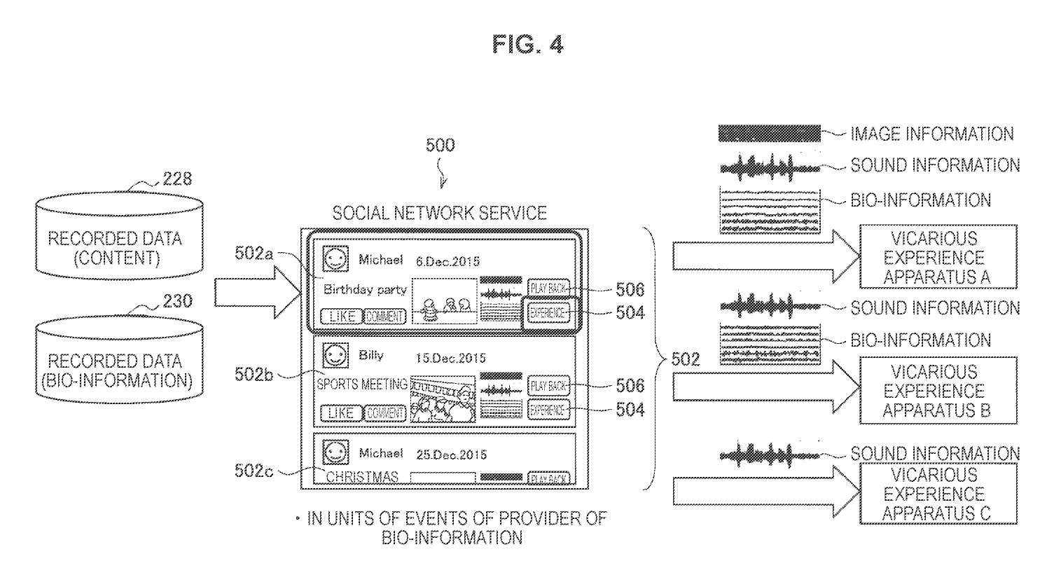

FIG. 4 is a schematic diagram illustrating a user interface (UI) of a social network service. The content information and the bio-information are supplied from the databases 228 and 230 to the social network service section 240 on the basis of a designation of making public by a user.

With such a configuration, as illustrated in a display example 500 in FIG. 4, information of content with bio-information 502 is listed on a display screen of the social network service. Specifically, the display example 500 is able to be displayed at the UI sections 118 and 314 of the recording apparatus 100 and the vicarious experience apparatus 300. The display example 500 illustrated in FIG. 4 is achieved by the social network service section 240 transmitting display information to the recording apparatus 100 or the vicarious experience apparatus 300, and the UI sections 118 and 314 performing display based on the display information.

As an example, information of the content with bio-information 502 is displayed chronologically in units of events of a provider on a timeline of the social network service. An experience button 504 is displayed together with the content with bio-information 502.

In a case where the content with bio-information 502 is selected by a viewer and the experience button 504 is pressed, recorded data of the content with bio-information 502 is played back in accordance with a type of the vicarious experience apparatus 300. As illustrated in FIG. 4, in a case where the user selects content with bio-information 502a and presses the vicarious experience button 504, various types of bio-information based on the bio-information is played back, together with the image (picture) information and the sound information, by a vicarious experience apparatus A. Further, in a case where the user selects the content with bio-information 502b and press the vicarious experience button 504, the various types of bio-information based on the bio-information is played back, together with the sound information, by a vicarious experience apparatus B; however, the image information is not played back. Further, in a case where the user selects the content 502c and presses the experience button 504, only sound information is played back by a vicarious experience apparatus C. In this way, information that is determined in accordance with the type of the vicarious experience apparatus 300 is able to be played back.

It is to be noted that, as illustrated in FIG. 4, a playback button 506 is provided, together with the experience button 504. In a case where the playback button 506 is pressed, the vicarious experience of the bio-information is not performed, and only the content information such as a text, a sound, and an image is played back by the content information playback section 301.

In a case where the bio-information is played back by the vicarious experience apparatus 300, for example, the HMD 302 plays back an image (picture) on the basis of image information that is photographed by the camera 110 of the recording apparatus 100 worn by the child 400 who is a bio-information acquisition target or image information that is photographed by the external camera 402. The speaker 304 plays back a sound on the basis of sound information that is recorded by the microphone 114 of the recording apparatus 100 worn by the child 400 or the external microphone 404. Further, the vibration generator 306 generates vibration on the basis of heartbeat or pulsation that is detected by the heartbeat sensor 102 of the recording apparatus 100 that is worn by the child 400. The humidifier 310 generates humidity in accordance with a perspiration amount that is detected by the perspiration sensor 106 of the recording apparatus 100 that is worn by the child 400. The heat generator 312 generates heat in accordance with a body temperature that is detected by the body temperature sensor 108 of the recording apparatus 100 that is worn by the child 400. With such a configuration, it is possible for the grandfather, as a person vicariously experiencing bio-information, of the child 400 to vicariously experience a state of tension or a state of excitement in a sports meeting that has been experienced by the child 400.

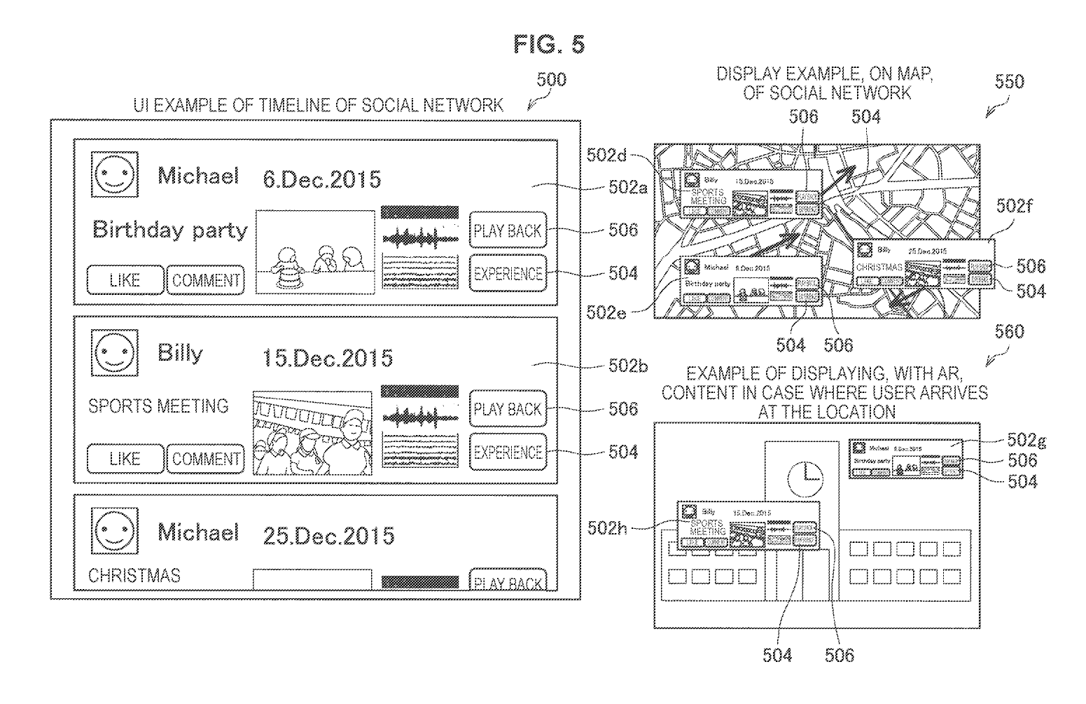

It is also possible to display a plurality of pieces of the content with bio-information on, for example, a map or a three-dimensional image, as well as on the timeline. In such a case as well, it is also possible for the user to perform selection in a similar manner to the above. In such a case as well, it is possible to display content that is able to be played back by subjecting to filtering, in accordance with the type of the vicarious experience apparatus 300 of the user performing the selection. By pressing the experience button that is associated with content, a vicarious experience method is automatically selected in accordance with bio-information of the selected content, and the playback is performed. FIG. 5 is a schematic diagram illustrating, in addition to the display example 500 on the timeline illustrated in FIG. 4, a display example 550 that displays, on a map, the content with bio-information 502, and a display example 560 that performs AR (Augmented Reality) display in a case where a user arrives at a corresponding location on the map. In the display example 550, locations, on the map, where the pieces of content with bio-information 502d, 502e, and 502f have been acquired are explicitly indicated, and display is performed in a state of the pieces of content with bio-information being associated with the locations on the map. In the display example 560, in a case where a user arrives at the locations where pieces of content with bio-information 502g and 502h have been acquired, information relating to the pieces of content with bio-information 502g and 502h is displayed with AR.

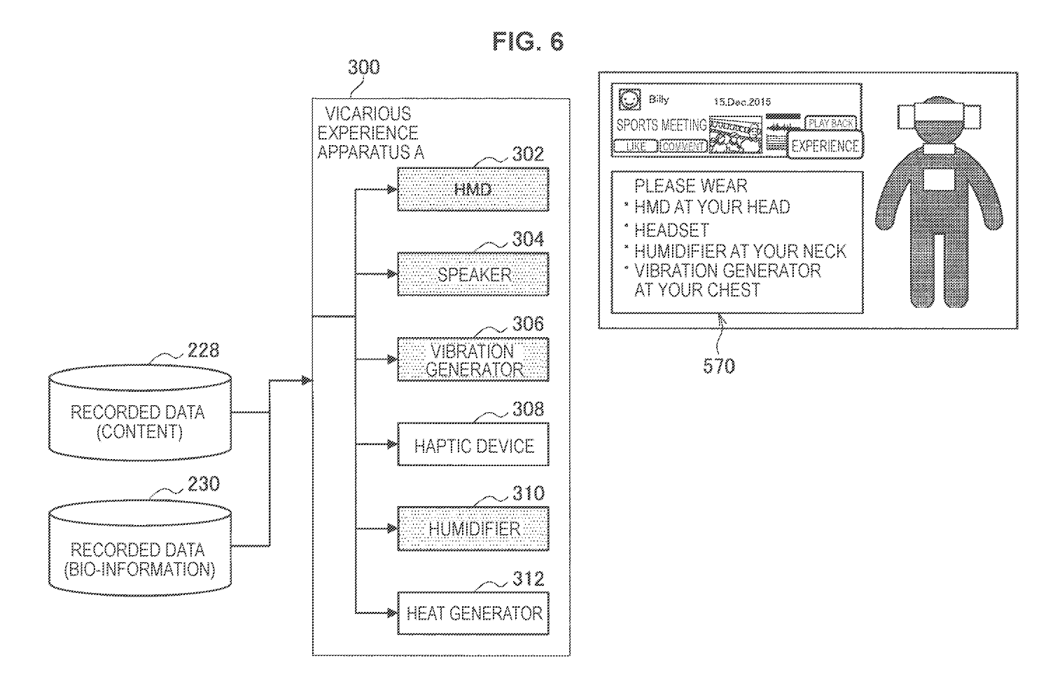

As described above, it is possible for the vicarious experience apparatus 300 to include various playback devices; however, the playback devices used in the vicarious experience apparatus 300 differ in accordance with the type of the content with bio-information. The devices to be used for playback in the vicarious experience apparatus 300 are needed to be properly worn by a user, while the devices that are not used for playback are not needed to be worn. For this reason, the vicarious experience method presentation section 224 presents, to the vicarious experience apparatus 300, a wearing location and usage of the vicarious experience apparatus 300 to be used, in accordance with recorded details (such as a data type and a condition at the time of recording). In an example illustrated in FIG. 6, as the vicarious experience apparatus 300, the HMD 302, the speaker 304, the vibration generator 306, the humidifier 310 are selected, and when a user presses the “experience button”, an announcement 570 of “Please wear an HMD at your head, a headset, a humidifier at your neck, and a vibration generator at your chest” is displayed at the UI section 314. When a user wears these devices at designated locations of the body, the content with bio-information is played back.

Further, although not illustrated in FIG. 6, the vicarious experience apparatus 300 may include a generator of a gas with an odor or a pressurizer. The generator of a gas with an odor generates, in a case of reproducing an environment directly, a smell of rain or a smell of sea, for example. In a case of reproducing an environment indirectly, the generator of a gas with an odor generates a smell that causes a user to feel relaxed or unpleasant. Further, the pressurizer reproduces load control of breathing by, for example, being worn at a user's chest. Furthermore, a context may be distributed with deformation, or may be distributed together with drug stimulation, physical stimulation, electrical stimulation, photic stimulation, sound stimulation, a feeling, or a vital sign. Further, a technique of allowing a user to feel synchronization in an illusory manner, without actually controlling breathing or heartbeat, is applicable. For example, a device to blow out air, for breathing, or a wearable type device that generates a vibration, for heartbeat, is usable.

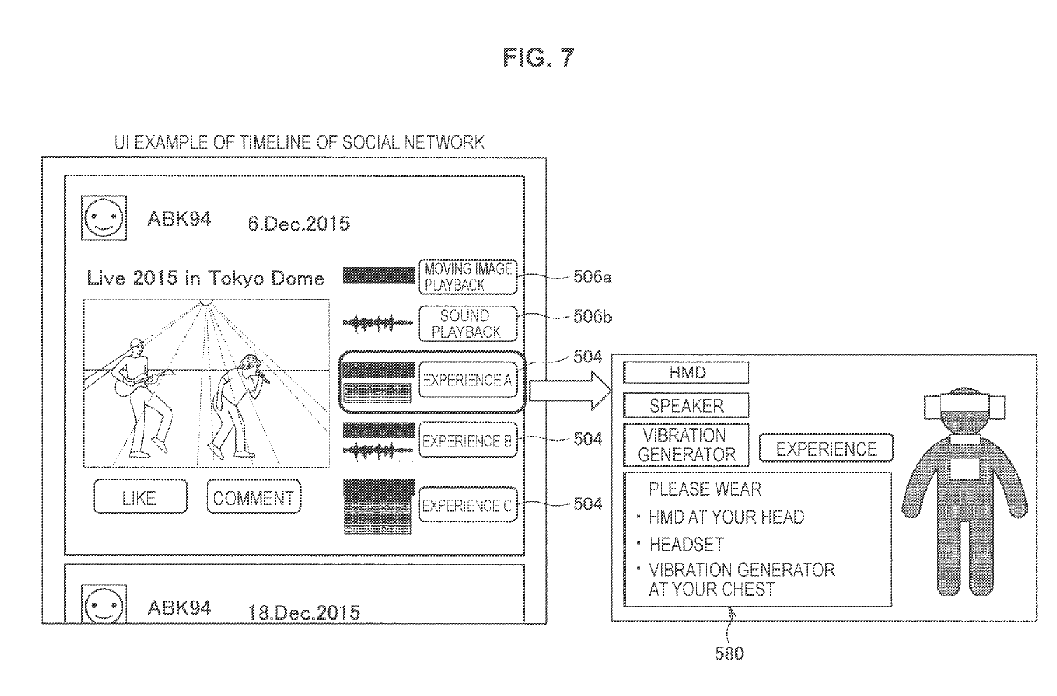

Next, a case of vicariously experiencing a performance of an idle singer (a bio-information acquisition target) is described by way of example, based on FIG. 7. First, the idle singer wears the recording apparatus 100, and bio-information (heartbeat, perspiration, blood pressure, body temperature, etc.) and content information such as an image, a sound, an activity (motion) during a live event are recorded. The recording of the bio-information and the generation of the content with bio-information are similar to those in the case of the above-described child 400.

The recorded content with bio-information is made public on a social network service, with an area open to the public being set, and a user selects a favorite content and presses the “experience button”. This causes the vicarious experience apparatus 300 (the HMD 302, the speaker 304, the vibration generator 306, the haptic device 308, the humidifier 310, the heat generator 312, etc.) worn by the user to play back a vibration, humidity control, heat generation control, etc. on the basis of a bio-information signal, and content information such as an image and a sound that is synchronized with the bio-information is played back.

FIG. 7 illustrates an example in which the content with bio-information of the idle singer is made public on a timeline of the social network. In this example, as the experience button 504, “experience A”, “experience B”, and “experience C” are displayed. The bio-information that is able to be experienced, and an amount of money to be charged are set to differ in accordance with the type of the experience button 504. As an example, in a case of pressing “experience A”, it is with a heartbeat-pulsation experience, and the charge is ¥100. In a case of pressing “experience B”, it is with a hot-air experience, and the charge is ¥200. Further, in a case of pressing “experience C”, it is possible to vicariously experience all of pieces of the bio-information, and the charge is ¥500. In such a case as well, an announcement 580 of “Please wear an HMD at your head, a headset, and a vibration generator at your chest” is displayed, prior to the start of a vicarious experience. Further, in the example illustrated in FIG. 7, a moving image playback button 506a and a sound playback button 506b are displayed as the playback button 506. In a case of pressing the moving image playback button 506a, only a moving image is played back, and a vicarious experience based on the bio-information is not performed. Further, in a case of pressing the moving image playback button 506b, only a sound is played back, and the vicarious experience based on the bio-information is not performed.

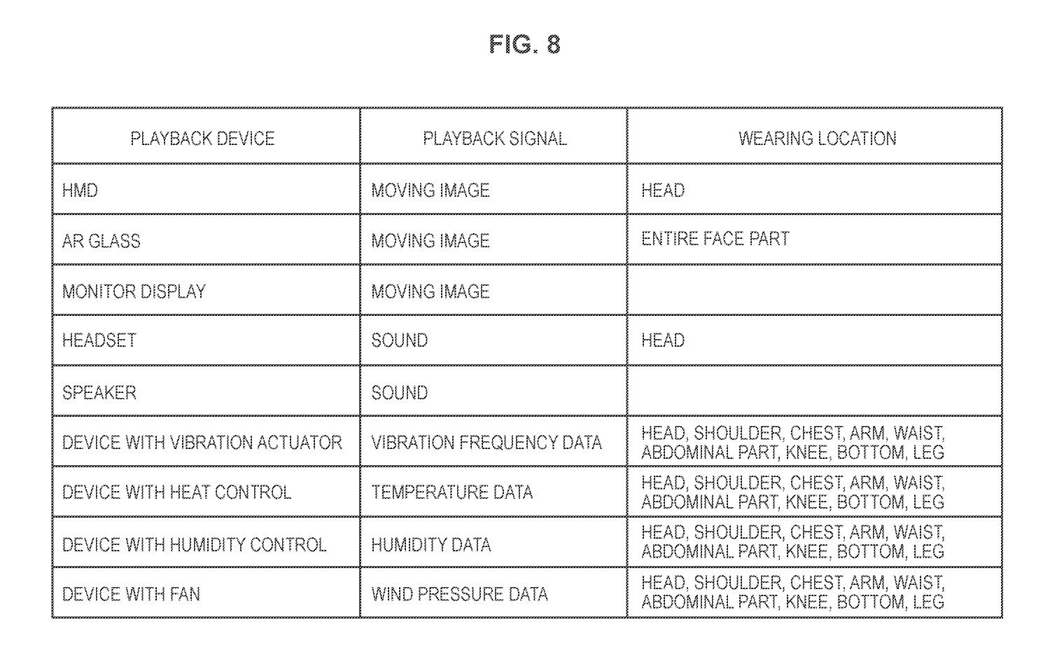

FIG. 8 is a schematic diagram illustrating an example of a presentation (instruction) of a vicarious experience method by the vicarious experience method presentation section 224. As illustrated in FIG. 8, a playback signal is defined, and a wearing location of each playback device is defined, in accordance with the type of a playback device of the vicarious experience apparatus 300. The vicarious experience method presentation section 224 presents usage including a wearing location of each of the playback devices, in accordance with a corresponding playback device.

As described above, according to the present embodiment, vicariously experiencing the bio-information allows a feeling or a vital sign to be experienced as content. This allows the person vicariously experiencing bio-information (for example, a parent of a child) to feel an experience of the bio-information acquisition target (for example, the child). Further, distributing the bio-information through a social network service allows a person vicariously experiencing bio-information located remotely to sympathize a feeling, which makes it possible to vicariously experience an experience of the bio-information acquisition target at the time of recording information more realistically.

In addition, an example is illustrated, in the present embodiment, in which the content with bio-information is shared with other users by using a social network, and the like. However, the present embodiment is non-limiting. For example, it is also possible to distribute bio-information together with content in content distribution such as streaming using virtual reality (VR streaming).

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing apparatus including:

a display controller that causes display that urges a user to perform an operation for playing back content that is associated with at least one piece of bio-information to be performed on a display section; and

a playback controller that, in accordance with the operation by the user, acquires the bio-information and the content from a storage section that stores the bio-information and the content, and causes the bio-information and the content to be played back.

(2)

The information processing apparatus according to claim 1, in which the content that is associated with the bio-information is acquired from a management section that is managed on a social network service.

(3)

The information processing apparatus according to (2), in which the display controller causes the display that urges the user to perform the operation to be performed on the display section on the social network service.

(4)

The information processing apparatus according to any one of (1) to (3), in which, in a case where a plurality of pieces of bio-information are associated with the content, the display controller causes the display that urges a plurality of the users in accordance with a number of pieces of the bio-information to perform the operation to be performed on the display section.

(5)

The information processing apparatus according to any one of (1) to (4), in which the display controller causes the display that urges the user to perform the operation for playing back only the content that is associated with the bio-information to be performed on the display section.

(6)

The information processing apparatus according to any one of (1) to (5, including a content with bio-information generation section that generates the content that is with bio-information on a basis of the bio-information and content information.

(7)

The information processing apparatus according to (6), in which the content information includes at least any of image information, sound information, or activity information.

(8)

The information processing apparatus according to any one of (1) to (7), including

a bio-information acquisition section that acquires the bio-information from a detection apparatus that detects the bio-information from a bio-information acquisition target.

(9)

The information processing apparatus according to (6), including:

a content information acquisition section that acquires the content information; and

a synchronization processing section that temporally synchronizes the bio-information with the content information.

(10)

The information processing apparatus according to any one of (1) to (9), in which the playback controller causes an experience apparatus to play back the content, the experience apparatus performing an operation for an experience based on the bio-information.

(11)

The information processing apparatus according to any one of (1) to (10), in which the operation by the user is at least one of an operation to an image that is displayed on the display controller, an operation through a sound of the user, or an operation through a gesture of the user.

(12)

The information processing apparatus according to (10), including:

a playback device selection section that selects, among a plurality of playback devices included in the experience apparatus, the playback device that is used for an experience; and

an experience method determination section that determines an experience method on a basis of the playback device that has been selected.

(13)

The information processing apparatus according to (12), including

an experience method presentation section that presents the experience method including, at least, usage of the playback device or a wearing location of the playback device.

(14)

The information processing apparatus according to (12), in which the experience method determination section determines the experience method on a basis of an instruction from a person experiencing bio-information who goes through an experience based on the bio-information.

(15)

The information processing apparatus according to (8), in which the detection apparatus includes at least one of a heartbeat sensor, a blood pressure sensor, a perspiration sensor, or a body temperature sensor.

(16)

The information processing apparatus according to (12), in which the playback device includes at least one of a head mounted display, a speaker, a vibration generator, a haptic device, a humidifier, a heat generator, a generator of a gas with an odor, or a pressurizer.

(17)

causing display that urges a user to perform an operation for playing back content that is associated with at least one piece of bio-information to be performed on a display section; and

acquiring, in accordance with the operation by the user, the bio-information and the content from a storage section that stores the bio-information and the content, and causing the bio-information and the content to be played back.

(18)

A program that causes a computer to function as:

a means of causing display that urges a user to perform an operation for playing back content that is associated with at least one piece of bio-information to be performed on a display section; and

a means of, in accordance with the operation by the user, acquiring the bio-information and the content from a storage section that stores the bio-information and the content, and causing the bio-information and the content to be played back.

### REFERENCE SIGNS LIST

100 recording apparatus
102 heartbeat sensor
104 blood pressure sensor
106 perspiration sensor
108 body temperature sensor
200 server
202 bio-information acquisition section
206 content information acquisition section
210 synchronization processing section
212 content with bio-information generation section
220 playback device selection section
222 vicarious experience method determination section
224 vicarious experience method presentation section
226 vicarious experience distribution section
228, 230 database
240 social network service section
242 SNS management section
244 SNS-UI section
300 vicarious experience apparatus
302 HMD
304 speaker
306 vibration generator
308 haptic device
310 humidifier
312 heat generator

1. An information processing apparatus comprising:
a display controller that causes display that urges a user to perform an operation for playing back content that is associated with at least one piece of bio-information to be performed on a display section; and
a playback controller that, in accordance with the operation by the user, acquires the bio-information and the content from a storage section that stores the bio-information and the content, and causes the bio-information and the content to be played back.

2. The information processing apparatus according to claim 1, wherein the content that is associated with the bio-information is acquired from a management section that is managed on a social network service.

3. The information processing apparatus according to claim 2, wherein the display controller causes the display that urges the user to perform the operation to be performed on the display section on the social network service.

4. The information processing apparatus according to claim 1, wherein, in a case where a plurality of pieces of bio-information are associated with the content, the display controller causes the display that urges a plurality of the users in accordance with a number of pieces of the bio-information to perform the operation to be performed on the display section.

5. The information processing apparatus according to claim 1, wherein the display controller causes the display that urges the user to perform the operation for playing back only the content that is associated with the bio-information to be performed on the display section.

6. The information processing apparatus according to claim 1, comprising
a content with bio-information generation section that generates the content that is with bio-information on a basis of the bio-information and content information.

7. The information processing apparatus according to claim 6, wherein the content information includes at least any of image information, sound information, or activity information.

8. The information processing apparatus according to claim 1, comprising
a bio-information acquisition section that acquires the bio-information from a detection apparatus that detects the bio-information from a bio-information acquisition target.

9. The information processing apparatus according to claim 6, comprising:
a content information acquisition section that acquires the content information; and
a synchronization processing section that temporally synchronizes the bio-information with the content information.

10. The information processing apparatus according to claim 1, wherein the playback controller causes an experience apparatus to play back the content, the experience apparatus performing an operation for an experience based on the bio-information.

11. The information processing apparatus according to claim 1, wherein the operation by the user is at least one of an operation to an image that is displayed on the display controller, an operation through a sound of the user, or an operation through a gesture of the user.

12. The information processing apparatus according to claim 10, comprising:
a playback device selection section that selects, among a plurality of playback devices included in the experience apparatus, the playback device that is used for an experience; and
an experience method determination section that determines an experience method on a basis of the playback device that has been selected.

13. The information processing apparatus according to claim 12, comprising
an experience method presentation section that presents the experience method including, at least, usage of the playback device or a wearing location of the playback device.

14. The information processing apparatus according to claim 12, wherein the experience method determination section determines the experience method on a basis of an instruction from a person experiencing bio-information who goes through an experience based on the bio-information.

15. The information processing apparatus according to claim 8, wherein the detection apparatus includes at least one of a heartbeat sensor, a blood pressure sensor, a perspiration sensor, or a body temperature sensor.

16. The information processing apparatus according to claim 12, wherein the playback device includes at least one of a head mounted display, a speaker, a vibration generator, a haptic device, a humidifier, a heat generator, a generator of a gas with an odor, or a pressurizer.

17. An information processing method comprising:
causing display that urges a user to perform an operation for playing back content that is associated with at least one piece of bio-information to be performed on a display section; and
acquiring, in accordance with the operation by the user, the bio-information and the content from a storage section that stores the bio-information and the content, and causing the bio-information and the content to be played back.

18. A program that causes a computer to function as:
a means of causing display that urges a user to perform an operation for playing back content that is associated with at least one piece of bio-information to be performed on a display section; and
a means of, in accordance with the operation by the user, acquiring the bio-information and the content from a storage section that stores the bio-information and the content, and causing the bio-information and the content to be played back.
